(19) United States
(12) Patent Application Publication
(10) Pub. No.: US 2003/0227783 A1
(43) Pub. Date: Dec. 11, 2003

(54) Circuit and method for controlling display power to a plasma display

(76) Inventors: Antonio Canova, Arezzo (IT); Lorenzo Cincinelli, Arezzo (IT); Mauro Piazzesi, Arezzo (IT)

Correspondence Address: WADDEY & PATTERSON, 414 UNION STREET, SUITE 2020, BANK OF AMERICA PLAZA, NASHVILLE, TN, 37219

(21) Appl. No.: 10/376,410

(22) Filed: Feb. 28, 2003

(30) Foreign Application Priority Data
Mar. 1, 2002 (EP) 02425113.4

(51) Int. Cl. H02M 3/335

(52) U.S. Cl. 363/21.02

(57) ABSTRACT

A power circuit for a plasma display includes a resonant converter. A current control loop and a voltage control loop are arranged between the load applied to the converter and the converter itself; the current control loop and the voltage control loop control responsive to converter output current and output voltage to control the working frequency of the converter.

This application claims benefit under 35 U.S.C. 119 (a) of co-pending European Application Serial No. 02425113.4 filed Mar. 1, 2002, in the European Patent Office, entitled “Power Circuit for a Plasma TV Display, Plasma Television Set Containing Said Circuit and Respective Powering Method” which is hereby incorporated by reference.

Be it known that we, Antonio Canova, Lorenzo Cincinelli and Mauro Piazzesi, Italian citizens residing in Arezzo, Italy, have invented a new and useful “Circuit and Method for Controlling Display Power to a Plasma Display.”

### BACKGROUND OF THE INVENTION

This invention relates to a power circuit for a plasma television display. The invention also relates to a plasma television containing said circuit and a method for controlling display power via the power circuit.

Plasma televisions have been known in the art for many years and are being increasingly more popular on the market thanks to recent technological perfecting. Patents related to plasma display technology include the following U.S. Pat. Nos. 4,130,777; 4,233,623; 4,329,626; 5,808,420; 6,211,867.

Plasma displays present considerable electrical power problems due to their high capacitance load. Currently, these types of displays are powered by means of PWM converters, generally of the flyback type for generating high voltage and of the forward type for generating low voltage. The use of these types of converters for powering plasma displays presents considerable problems and shortcomings. Particularly, high dV/dt and dl/dt switching (hard switching) with generation of high frequency harmonics cause problems of electromagnetic interference and the performance is not always high.

### SUMMARY OF THE INVENTION

One object of the present invention is to provide a power circuit for plasma displays which overcomes the shortcomings of traditional power systems. Another object of the invention is the realization of a display for televisions and the like, with a new power circuit.

Essentially, according to the invention, a plasma display is powered by a power circuit comprising a resonant converter and, preferably, a resonant converter in a series-parallel configuration. The invention is therefore based on a new use of the resonant converter, characterized in that said converter is used in a plasma display power circuit.

A number of advantages are obtained by using a resonant converter to power a plasma display, some of which are listed below:

the converter MOSFETs switch at zero voltage and zero current (Zero Voltage Switching, Zero Current Switching) which entails highly efficient switching;

the current waveform is nearly sinusoidal and this entails a considerable reduction of conducted and irradiated noise; minimal electromagnetic shielding is required;

the circuit is cost-effective and employs a low number of components, because it exploits the parasitic capacitance of semiconductors (MOSFETs) of the half bridge of the converter and the leakage inductance of the transformer;

a single winding is used, which additionally simplifies assembly and reduces device weight.

According to a particularly advantageous embodiment of the invention, the power circuit comprises a current control loop and a voltage control loop between the load applied to the converter and the converter itself. The loops control the working frequency of the converter. By means of this arrangement it is possible to limit the current output from the power circuit to the display at turn-on, in spite of the high capacitance of the load applied to the converter. Power is voltage controlled when the capacitance of the display is charged at the required voltage. The current control ring will start working again in the event of over-current.

In practice, the current control loop and the voltage control loop are connected to the converter according to an alternative configuration, by which the current control ring is active when a voltage lower than a predetermined value is present between the output terminals of the converter, while the voltage control loop is active when a voltage exceeding said predetermined value is present between the output terminals of the converter. For this purpose, corresponding one-way components, essentially consisting of respective diodes, are advantageously arranged on the output of respective operational amplifiers inserted in said two control loops.

Advantageously, the voltage and current control loops are galvanically isolated from the switching control circuit of the converter, e.g. by interposing an optical coupler, i.e. a photocoupler.

The circuit according to the invention can be used to implement a method for powering a plasma display, e.g. a television display, characterized in that: said display is powered by a resonant converter; in that the output current and voltage of said converter are controlled by a current control loop and a voltage control loop, the power current being limited by said current control ring until the output voltage of said converter has reached a predetermined value.

### BRIEF DESCRIPTION OF THE DRAWINGS

FIG. 1 is a simplified circuit diagram of the power circuit according to the invention applied to a plasma display.

FIG. 2 shows the current and voltage waveform patterns at the output of the power circuit according to the invention when the display is turned on;

FIG. 3 is a more detailed schematic of one embodiment of the circuit according to the invention.

### DESCRIPTION OF THE PREFERRED EMBODIMENTS

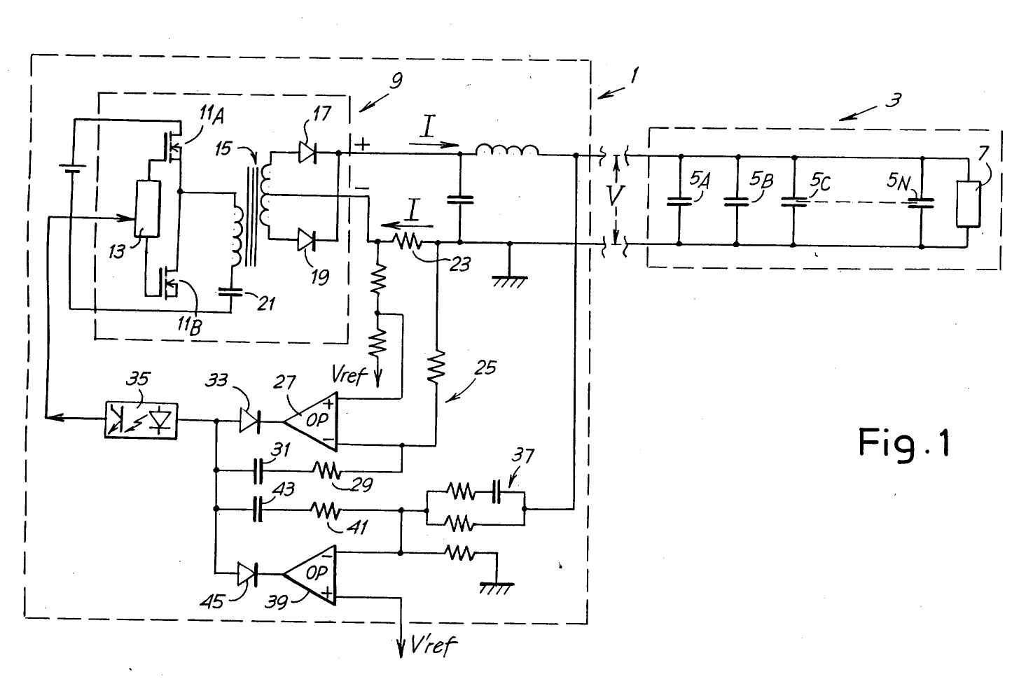

FIG. 1 schematically shows a power circuit of a plasma display according to the invention. The power circuit is generally indicated by reference numeral 1 and the plasma display is generally indicated by reference numeral 3 and schematically illustrated in the form of a capacitive system consisting of the parallel arrangement of a plurality of capacitors 5A, 5B, . . . 5N and a generic load 7.

The power circuit 1 comprises a resonant converter in series-parallel configuration, indicated by reference numeral 9. This type of converter is generally known and operation of the device will not be described in detail herein. For a detailed theoretical description of the operation of this type of converter, reference can be made to M. K. Kazimierczuk, “Class D Voltage Switching Power Inverter”, IEE Proc. Volume 138, November 1991; M. K. Kazimierczuk and W. Szaraniec, “Class D Voltage Switching Inverter with Only One Shunt Capacitor”, IEE Proc. Volume 139, September 1992; Marian K. Kazimierczuk, Dariusz Czarkowski, “Resonant Power Converters”, Editor John Wiley & Sons Inc., 1995.

In the diagram of FIG. 1, references 11A and 11B indicate two MOSFETs in half-bridge configuration, whose switching is controlled by a converter control circuit 13. This may be, for example, an integrated circuit of the IR21 571 family made by International Rectifier (USA), or an L6598 integrated circuit made by STM (Italy), or other equivalent circuit. The half-bridge arrangement of the MOSFET'S is connected to a converter output circuit wherein reference numeral 15 indicates the output transformer and reference numerals 17, 19 indicate the two rectifier diodes on the secondary winding output of the transformer 15. Reference numeral 21 indicates the resonant capacitor in series with the primary winding of the transformer 15. The resonant capacitance in parallel of the primary winding of the transformer 15 is represented by the internal parasitic capacitance of the two MOSFETs 11A, 11B.

A current sensor is arranged on the negative output terminal of the converter 9, specifically a reading resistor 23, which reads the current output by the converter 9 to the display 3. The voltage drop at the terminals of the reading resistor 23 is proportional to the current I output by the converter 9 and is used in a current control loop, generally indicated by reference numeral 25, to limit the maximum value of output current.

The current control loop 25 comprises a first operational amplifier 27 to whose inverting terminal a voltage, which is proportional to the voltage upstream to the reading resistor 23, is applied. A reference voltage, determined by the voltage Vref, is applied to the non-inverting terminal of the operational amplifier 27. Reference numerals 29 and 31 indicate a resistor and a capacitor of the reaction branch of the operational amplifier 27, between the inverting terminal and the output. The output of the operational amplifier 27 is connected, via a diode 33, to a photocoupler 35. The output signal of the operational amplifier 27 is thus transmitted to the control circuit 13, for the purposes described below, following galvanic uncoupling.

In addition to the current control loop described above, the power circuit 1 comprises a voltage control loop, generally indicated by reference numeral 37. The loop 37 comprises a second operational amplifier 39, on whose inverting input a voltage, which is proportional to the voltage applied by the converter 9 to the load, i.e. the plasma display 3, is applied. A reference voltage is applied to the non-inverting input of the operational amplifier 39. A reaction branch, comprising a resistor 41 and a capacitor 43, is arranged between the inverting input and output of the operational amplifier 39. Similarly to the output of the first operational amplifier 27, the second operational amplifier output 39 is connected to the photocoupler 35 via a diode 45.

The operation of the circuit 1 described so far is as follows. The capacitors 5A . . . 5N are discharged when the display 3 is turned on. Due to the very high capacitance of the capacitors (in the order of several thousands of microfarads), the switching of the power circuit 1 would short-circuit the converter 9, with consequent irreversible damage to internal components. The purpose of the current control loop 25 is to avoid this event, by imposing a maximum current value. When the display 3 is turned on, the output of the first operational amplifier 27 is kept at a low level by the high voltage drop on the reading resistor 23, because the voltage applied to the inverting terminal (voltage upstream to the reading resistor 23) prevails on the reference voltage applied to the non-inverting terminal. Consequently, the diode 33 is switched to conducting and a signal is sent to the control circuit 13 by the photocoupler 35. The signal tends to reduce the switching frequency of the MOSFETs 11A, 11B, distancing it from the working frequency, which in turn is higher than the resonance frequency.

Following a current peak output by the power circuit 1 caused by the inevitable delay in the operation of the current control loop 25, the signal output by the first operational amplifier 27 keeps the value of the current I at a constant and controlled level with a gradual increase of output voltage of the first operational amplifier 27 and a consequent reduction of the emission of the photodiode of the photocoupler 35, due to the gradual accumulation of charge in the capacitors 5A . . . 5N of the display 3. The switching frequency of the converter 9 is consequently reduced.

During this initial phase, the output of the second operational amplifier 39 is high and the diode 45 is blocked. Consequently, the voltage control loop 37 is not active.

The capacitors 5A . . . 5N of the display 3 are gradually charged as the current controlled by the current control loop 25 flows through the display 3. Consequently, the voltage V between the output terminals of power circuit 1 increases gradually until the voltage applied to the inverting terminal of the second operational amplified 39 prevails on the reference voltage applied to the corresponding non-inverting terminal. Consequently, the output voltage of the second operational amplifier 39 is lowered and the diode 45 switches to conduction. T he corresponding increase of the output voltage of the first operational amplifier 27 blocks the diode 33. In this way, the voltage control loop 37 comes into operation while the current control loop 25 is deactivated and the switching frequency of the converter 9 reaches running value.

During normal operation of the device, the switching frequency control and, consequently, the power conditions, is governed by the voltage control loop 37, unless an over-current occurs, in which case the current control loop 25 limits the current I to a maximum value.

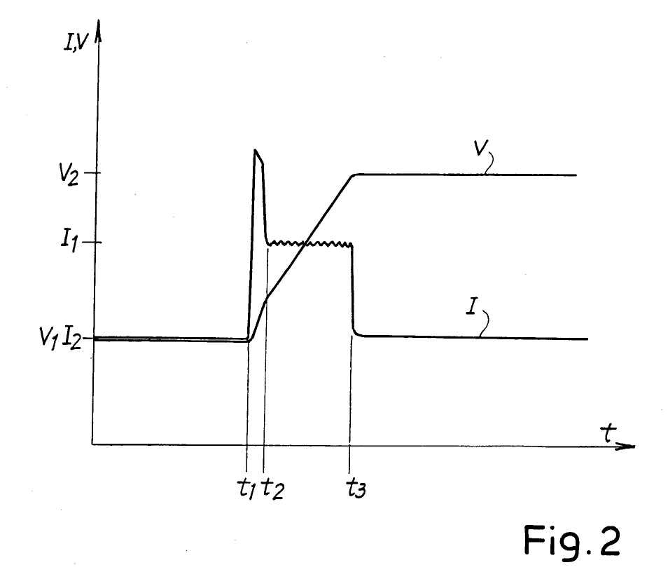

FIG. 2 shows the waveforms of the current I and the voltage V when the display 3 is switched on. The converter is switched on in instant t1. A current peak due to the delay in current control loop operation occurs between instant t1 and t2. Between instant t2 and instant t3, the current I is kept at a level I1 which is essentially constant and is returned to a minimum value I2 in instant t3. At the same time, the voltage V increases from the value V1 to the value V2, which is reached in instant t3 in an essentially linear fashion. Instant t3 is when the running voltage across the capacitors 5A . . . 5N of the display 3 is reached.

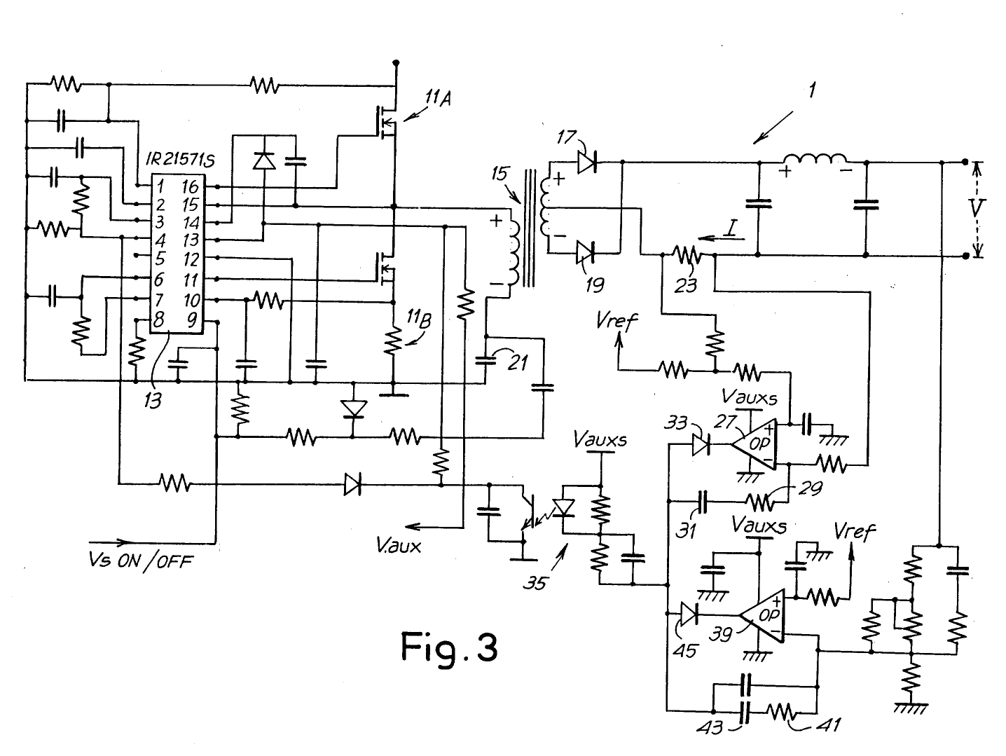

FIG. 3 shows a more detailed circuit diagram of a form of embodiment of the power circuit 1 shown in FIG. 1. Equal reference numerals indicate parts which are either equal or corresponding to those in FIG. 1.

The center-tapped transformer and the arrangement of the two diodes 17, 19 can clearly be replaced with equivalent arrangements, e.g. by a non-center-tapped transformer and a diode bridge rectifier.

It should be understood that the drawing shows only a possible embodiment of the invention which may vary in its forms and arrangements without departing from the scope of the concept underlying the invention. The possible presence of reference numbers in the enclosed claims has only the purpose of facilitating the reading of the claims in view of the above description and of the enclosed drawings and does not limit their scope of protection.

What is claimed is:

1. A power circuit for a plasma display comprising a resonant converter, the resonant converter comprising a control circuit and a converter output circuit adapted for electrically coupling to the display.

2. The power circuit according to claim 1 further comprising a current control loop and a voltage control loop each electrically connected between the converter output circuit and the converter control circuit, said current control loop and said voltage control loop controlling an operating frequency of the converter.

3. The power circuit according to claim 2 wherein the converter output circuit includes converter output terminals, the power circuit further characterized in that said current control loop and said voltage control loop are connected to the converter in an alternative configuration such that the current control loop is active when a voltage lower than a predetermined value is present between the output terminals of the converter, while the voltage control loop is active when a voltage excessive of said predetermined value is present between the output terminals of the converter.

4. The power circuit according to either claim 2 or 3 wherein said current control loop and said voltage control loop are connected to the converter control circuit via an isolated coupling.

5. The power circuit according to claim 4, said isolated coupling comprising an optical coupler.

6. The power circuit according to either of claims 2 or 3, said current control loop comprising a sensor for detecting a current output from said converter.

7. The power circuit according claim 3, wherein said current control loop comprises a first operational amplifier having an inverting input, a non-inverting input, and an output, the inverting input of the first operational amplifier connected to a voltage which is proportional to a current output from the converter, and the non-inverting input of the first operational amplifier connected to a reference voltage.

8. The power circuit according to claim 7, the output of the first operational amplifier is electrically connected to said isolated coupling through a first diode.

9. The power circuit according to claim 7, wherein said voltage control loop comprises a second operational amplifier having an inverting input, a non-inverting input, and an output, the inverting input of the second operational amplifier connected to a voltage which is proportional to a voltage output from converter, and the non-inverting input of the second operational amplifier connected to a reference voltage.

10. The power circuit according to claim 9, the output of said second operational amplifier electrically connected to said isolated coupling by a second diode.

11. The power circuit of claim 1 wherein said converter is a series-parallel resonant converter.

12. A plasma display comprising a load and a power circuit, the power circuit comprising a resonant converter, the resonant converter comprising a control circuit and a converter output circuit electrically coupled to the load.

13. A method for powering a plasma display, the method comprising providing a resonant converter and electrically coupling the resonant converter to the display.

14. The method according to claim 13, further comprising controlling an output current and an output voltage of said converter by a current control loop and a voltage control loop, the power current being limited by said current control loop until the output voltage of said converter reaches a predetermined value.
